(19) United States
(12) Patent Application Publication
(10) Pub. No.: US 2018/0246835 A1
(43) Pub. Date: Aug. 30, 2018

(54) DATA TRANSMISSION METHOD FOR SGPIO

(71) Applicants: INVENTEC (PUDONG) TECHNOLOGY CORPORATION, Shanghai City (CN); INVENTEC CORPORATION, Taipei City (TW)

(72) Inventors: Chun-Chieh LU, Taipei City (TW); Hsiang-Chun HU, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/743,611

(22) PCT Filed: Mar. 25, 2016
(86) PCT No.: PCT/CN2016/077346

§ 371 Date: Jan. 10, 2018

(30) Foreign Application Priority Data
Nov. 20, 2015 (CN) 201510810462.4

(51) Int. Cl. G06F 13/40; G06F 13/16; G06F 13/42

(52) U.S. Cl. CPC G06F 13/4068; G06F 13/1668; G06F 2213/0036; G06F 2213/0016; G06F 13/4282

(57) ABSTRACT

Disclosed is a data transmission method of SGPIO that is applied to an expander and a target device connected by a SGPIO bus. The SGPIO bus at least includes a data output line and a data reading line. The expander outputs a page assign signal to the target device through the data output line. The page assign signal indicates a page address. The target device searches for at least one piece of page data at the page address according to the page assign signal. The target device outputs the page data to the expander through the data reading line. The expander reads the information transmitted through the data reading line. When the expander determines that the information transmitted through the data reading line includes the page address, the expander receives the page data.

### CROSS-REFERENCE TO RELATED APPLICATIONS

This non-provisional application claims priority under 35 U.S.C. § 119(a) on Patent Application No(s). 201510810462.4 filed in China on Nov. 20, 2015, the entire contents of which are hereby incorporated by reference.

### BACKGROUND

### Technical Field

The disclosure relates to a data transmission method of serial general purpose input output (SGPIO), more particularly to a data transmission method applied to an expander and a target device that are connected via a SGPIO bus.

### Related Art

With the development of technology, it has been expected to increase the speed and quantity of data of the data transmission between electronic devices. To achieve the fast transmission of a great deal of data between electronic devices, SGPIO buses, inter-integrated circuits (I2Cs) or universal asynchronous receiver transmitters (UART) are usually employed in the modern technology in the art to carry out the data transmission between an expander or initiator and a target device.

However, when the data transmission between an expander and a target device is performed via a SGPIO bus, the SGPIO bus architecture in the art requires allotting and defining the certain number of time slots to the target device in advance so that the target device can transmit corresponding data to the expander via the time slots defined in advance. Consequently, the number of time slots allotted and defined in advance limits the quantity of data that can be transmitted from the target device to the expander. For example, there are 60 time slots predefined for a target device to transmit data to an expander, and thus, the target device only can transmit 60 pieces of different data to the expander at most.

### SUMMARY

According to one or more embodiments of the present disclosure, the data transmission method of SGPIO is applied to an expander and a target device that are connected via a SGPIO bus. The SGPIO bus at least includes a data output line and a data reading line. The expander outputs a page assign signal to the target device via the data output line, and the page assign signal indicates a page address. The target device, according to the page assign signal, searches for page data indicated by the page address. The target device outputs the page address and the found page data to the expander via the data reading line. The expander reads information send from the data reading line. When the expander determines that the information sent by the data reading line includes the page address, the expander receives the page data.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view illustrating that a SGPIO bus is electrically connected to an expander and a target device in an embodiment of the disclosure;

FIG. 2 is a schematic view of the allocation of time slots of the SGPIO bus in an embodiment of the disclosure;

FIG. 3 is a flow chart of a data transmission method of SGPIO in an embodiment of the disclosure; and

FIG. 4 is a flow chart of a data transmission method of SGPIO in another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

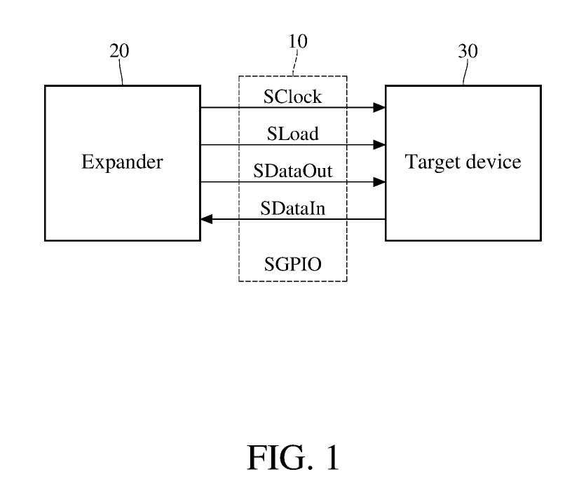

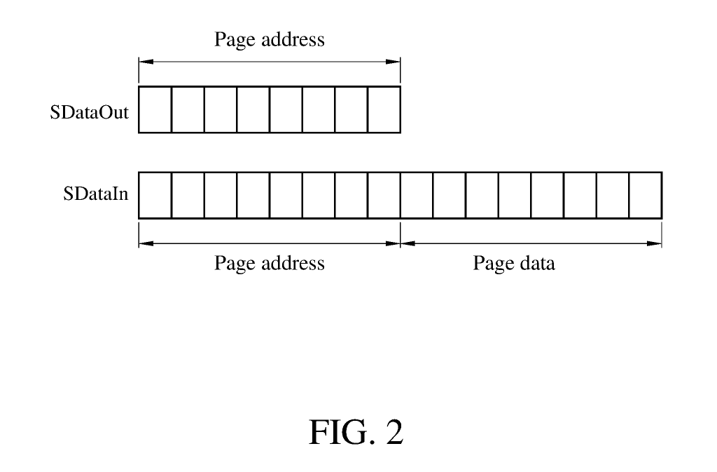

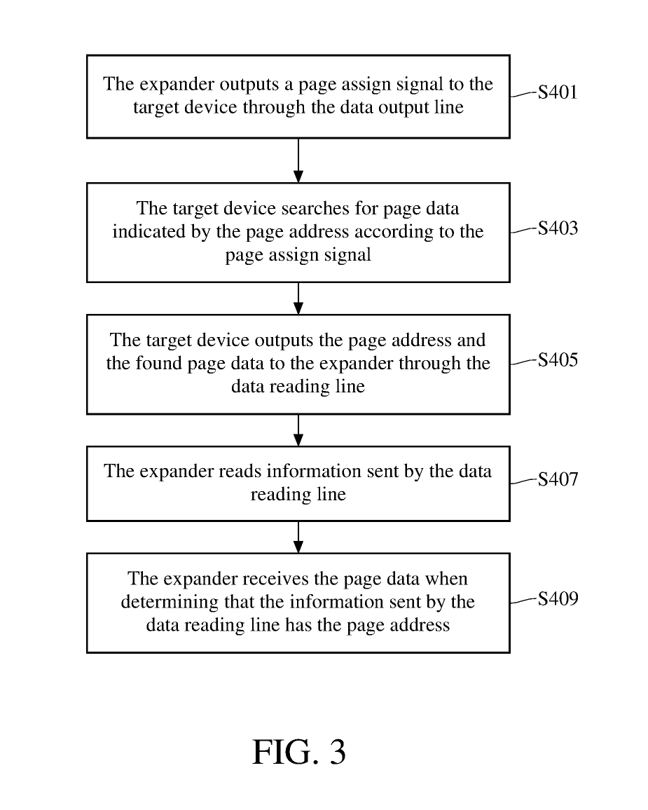

Please refer to FIG. 1. FIG. 1 is a schematic view illustrating that a SGPIO bus is electrically connected to an expander and a target device in an embodiment of the disclosure, FIG. 2 is a schematic view of the allocation of time slots of the SGPIO bus in an embodiment of the disclosure, and FIG. 3 is a flow chart of a data transmission method of SGPIO in an embodiment of the disclosure. As shown in the figures, the data transmission method of SGPIO in the disclosure is applied to a case that an expander 20 and a target device 30 are connected to a SGPIO bus 10. For example, the expander 20 is a serial attached small computer system interface (SCSI) expander, a microcontroller, an embedded controller, a baseboard management controller (BMC) or other suitable device. For instance, the target device 30 is a backplane module, or a disk array device including hard disk drives, a spare battery, a control unit and a fan, a great array of just bundle of disks (JBOD), a great redundant array of independent disks (RAID), a programmable logic device (PLD), a complex PLD (CPLD), a field-programmable gate array (FPGA) or other suitable device.

The SGPIO bus 10 includes a data output line SDataOut, a data reading line SDataIn, a clock signal line SClock and a load signal line SLoad. The expander 20 and the target device 30 individually have their own one or more clock pins, load pins, data input pins and data output pins, and the pins of the expander 20 are electrically connected to and the corresponding pins of the target device 30 through the data output line SDataOut, data reading line SDataIn, clock signal line SClock and load signal line SLoad of the SGPIO bus 10, respectively. The expander 20 is defined as a SGPIO initiator of the SGPIO bus 10 while the target device 30 is defined as a SGPIO target of the SGPIO bus 10. All those who have ordinary skill in the art can understand the implementation of connecting the expander 20 and the target device 30 through the SGPIO bus 10, and thus, the related detail thereof will not be described hereafter.

In the SGPIO bus 10, the clock signal line SClock allows the expander 20 to transmit a clock signal to the target device 30, the load signal line SLoad allows the expander 20 to transmit a load signal to the target device 30, the data output line SDataOut allows the expander 20 to transmit a signal to the target device 30, and the data reading line SDataIn allows the target device 30 to send a signal to the expander 20. Here, the clock signal is used to define a transfer clock for the SGPIO bus 10; and the load signal is used to define the frame of transfer data in the data output line SDataOut or the data reading line SDataIn, and for example, a transfer frame in the load signal continues for 8 clock cycles of the clock signal triggered at a rising edge of the first clock cycle and then ending at a falling edge of the last clock cycle.

When the expander 20 and the target device 30 intend to perform data transmission therebetween through the SGPIO bus 10, the expander 20 outputs a page assign signal to the target device 30 through the data output line SDataOut, in order to indicate a page address via the page assign signal (step S401). In step S403, the target device 30 searches for page data indicated by the page address provided in the page assign signal. In step S405, the target device 30 outputs the page address and the found page data to the expander 20 through the data reading line SDataIn. In step S407, the expander 20 reads information sent by the data reading line SDataIn. In step S409, when the expander 20 determines that the information sent by the data reading line SDataIn has the page address, the expander 20 receives the page data.

In detail, the SGPIO bus 10 allocates time slots of the data output line SDataOut and the data reading line SDataIn. For example, 8 time slots of the data output line SDataOut are allocated for the transmission of the page assign signal, 8 time slots of the data reading line SDataIn are allocated for the transmission of the page address, and other 8 time slots of the data reading line SDataIn are allocated for the transmission of the page data at the page address. In practice, assume the expander 20 is a microprocessor and the target device is a CPLD. In this case, when the microprocessor and the CPLD intend to perform data transmission therebetween, the microprocessor will send a page assign signal to the CPLD through 8 time slots of the data output line SDataOut for requesting the CPLD to provide the information the microprocessor needs. When the CPLD receives the page assign signal, the CPLD switches to a page to which the page address indicated by the page assign signal directs, and the CPLD sends the page address and the page data at the page address to the microprocessor through the data reading line SDataIn.

In this embodiment, the page assign signal is an 8-bit signal so needs 8 time slots for transmission. In addition to adapting to the 8 bits of the page assign signal, the data reading line SDataIn also allocates 8 time slots to the CPLD for the transmission of the page address, and other 8 time slots to the CPLD for the transmission of the page data.

Accordingly, the microprocessor can not only actively request the CPLD to provide data, but also use a page assign signal to point out which data the microprocessor needs. This course is different from what is used to be in the related art, in which a CPLD directly sends data to a microprocessor. Therefore, the information transmitted between the CPLD and the microprocessor may become more various. In an example, in the art, a CPLD only can send 16 pieces of data to a microprocessor at most if intending to use 16 time slots of the data reading line SDataIn to send data to the microprocessor. In contrast, for the present disclosure, a microprocessor can actively request a CPLD for data, send a page assign signal using 8 time slots of the data output line SDataOut, and also send out page data using other 8 time slots of the data reading line SDataIn; and then the CPLD can provide 8×2⁸ or more pieces of data to the microprocessor.

That is to say, the CPLD respectively assigns every 8 pieces of data among 8×2⁸ pieces of data to one of 28 page addresses, and when the CPLD receives an active request from the microprocessor for page data at one of 28 page addresses, the CPLD employs 16 time slots of the data reading line SDataIn to send the page address requested by the microprocessor and 8 pieces of data at the page address to the microprocessor. In another embodiment, each page address defined in the CPLD can direct to the more or less amount of pieces of data. For example, a page address defined in the CPLD directs to 16 pieces of page data, and when the microprocessor requests the CPLD to provide page data at the page address, the CPLD outputs 16 pieces of page data to the microprocessor batch by batch. Here, the CPLD can segment the 16 pieces of page data, at the page address, into two batches and send the 16 pieces of page data to the microprocessor batch by batch.

In this embodiment, the CPLD, according to the page assign signal outputted by the microprocessor, outputs all page data at the page address to the microprocessor as a whole or batch by batch (i.e. as separate parts); and in other embodiments, the microprocessor can appoint the CPLD to output a part of page data of a page by other suitable methods, such as allocating another time slot and thereby transmitting a request signal, and the other suitable methods are not limited to this example. Further, this embodiment does not limit to that each page address corresponds to the same number of pieces of data, and all those who have ordinary skill in the art can allot the respect number of pieces of page data to a respect page address according to actual requirements. In addition, in the aforementioned embodiment, the number of time slots in the data output line SDataOut for the transmission of the page assign signal and the number of time slots in the data reading line SDataIn for the transmission of the page address and related page data are exemplified only for easy explanations rather than for limiting other possible embodiments in the disclosure.

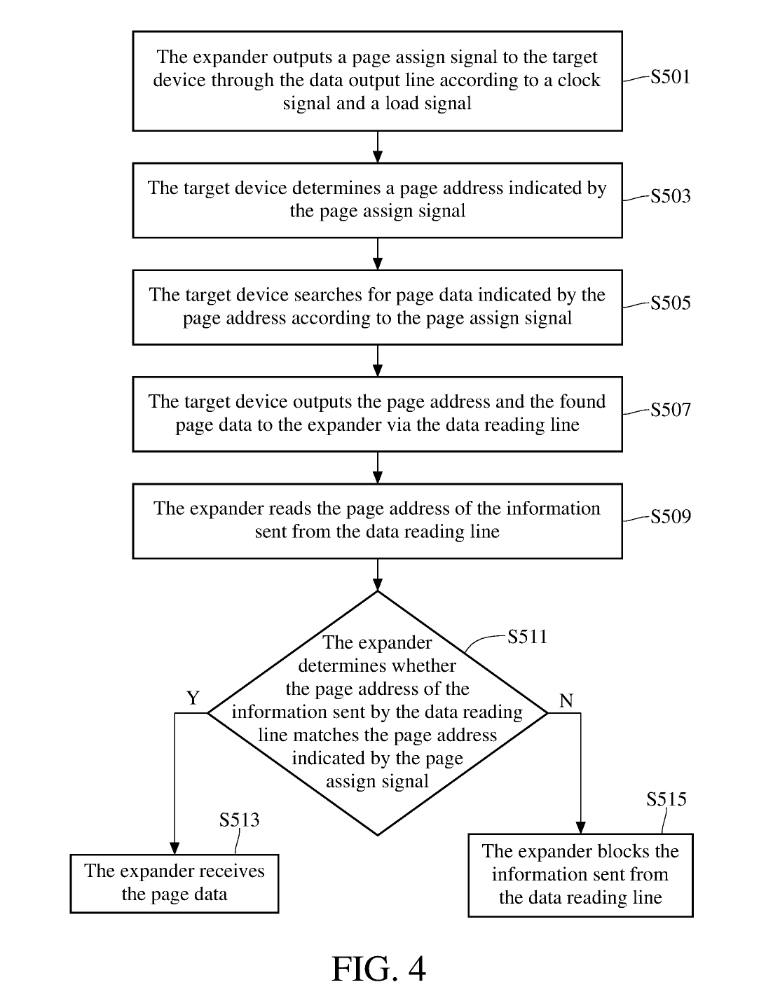

To further clarify the data transmission method of SGPIO in the disclosure, another embodiment is described as follows with reference to FIG. 1 and FIG. 4. FIG. 4 is a flow chart of a data transmission method of SGPIO in another embodiment of the disclosure. As shown in FIG. 4, in step S501, the expander 20 outputs a page assign signal to the target device 30 through the data output line SDataOut according to a clock signal and a load signal; that is, the expander 20 transmits the page assign signal according to the cycle of the clock signal and the signal frame of the load signal, and when the page assign signal is an 8-bit signal, the expander 20 outputs the first bit at the rising edge of the load signal and outputs a bit at each of the 8 cycles of the clock signal.

In step S503, the target device 30 determines a page address indicated by the page assign signal, and in step S505, searches for page data indicated by the page address according to the page assign signal. Then, in step S507, the target device 30 outputs the page address and the found page data to the expander 20 via time slots allocated in the data reading line SDataIn. In step S509, the expander 20 reads the page address of the information sent from the data reading line SDataIn, and in step S511, determines whether the page address of the information sent by the data reading line SDataIn matches the page address indicated by the page assign signal outputted to the target device 30. When the page address of the information sent by the data reading line SDataIn matches the page address outputted to the target device 30, the expander 20 receives the page data sent from the data reading line SDataIn in step S513. That is, after the target device 30 sends the page address and the page data thereof to the expander 20, the expander 20 further determines whether the page address transmitted by the time slot assigned for the transmission of page addresses in the data reading line SDataIn matches the page address that is requested; and if the two page addresses match, the expander 20 then receives the page data sent by the data reading line SDataIn.

Additionally, when the page address of the information sent by the data reading line SDataIn does not match the page address outputted to the target device 30, the expander 20 blocks the information sent from the data reading line SDataIn in step S515.

To sum up, the data transmission method of SGPIO provided in the embodiments of the disclosure is applied to an expander and a target device which are connected via a SGPIO bus. In the embodiments of the disclosure, the expander actively outputs a page assign signal to the target device so that the target device searches for page data at a page address indicated by the page assign signal, and sends the found page data to the expander. Therefore, the target device may be able to transmit more pieces of data to the expander via the SGPIO bus. In an embodiment, the expander outputs the page data at the page address to the expander as a whole or as separate parts, and when the expander or the target device does not support any I2C or UART transmission interface, the data transmission between the expander and the target device can be carried out by the SGPIO bus, and the SGPIO bus also support the transmission of various data.

What is claimed is:

1. A data transmission method of serial general purpose input output (SGPIO), applied to an expander and a target device which are connected by a SGPIO bus at least comprising a data output line and a data reading line, and the data transmission method comprising:
the expander outputting a page assign signal, which indicates a page address, to the target device through the data output line;
the target device, according to the page assign signal, searching for at least one piece of page data indicated by the page address;
the target device outputting the page address and the at least one piece of page data to the expander through the data reading line;
the expander reading information sent by the data reading line; and
the expander receiving the at least one piece of page data when the expander determines that the information sent by the data reading line comprises the page address.

2. The data transmission method according to claim 1, further comprising:
allocating a plurality of time slots of the data output line to send the page assign signal by a part of the plurality of time slots.

3. The data transmission method according to claim 1, further comprising:
allocating a plurality of time slots of the data reading line to send the page address by a part of the plurality of time slots of the data reading line and send the at least one piece of page data by another part of the plurality of time slots.

4. The data transmission method according to claim 3, wherein the target device outputs the at least one piece of page data page data, at the page address, to the expander batch by batch.

5. The data transmission method according to claim 4, wherein outputting the page address and the at least one piece of page data to the expander through the data reading line by the target device comprising:
the target device outputting all page data, which is at the page address, to the expander.

6. The data transmission method according to claim 1, wherein the SGPIO bus further comprises a clock signal line and a load signal line, the clock signal line sends a clock signal, the load signal line sends a load signal, and outputting the page assign signal to the target device through the data output line comprises:
outputting the page assign signal according to the clock signal and the load signal.

7. The data transmission method according to claim 1, wherein reading the information sent by the data reading line comprises:
reading the page address existing in the information sent by the data reading line.

8. The data transmission method according to claim 7, further comprising:
the expander determining whether the page address that is read matches the page address indicated by the page assign signal outputted to the target device.

9. The data transmission method according to claim 8, wherein when the expander determines that the page address that is read does not match the page address indicated by the page assign signal, the expander does not block the information sent by the data reading line.

10. The data transmission method according to claim 1, further comprising:
the target device determining the page address indicated by the page assign signal.
